(19) United States
(12) Patent Application Publication
(10) Pub. No.: US 2016/0078676 A1
(43) Pub. Date: Mar. 17, 2016

(54) ELECTRONIC DEVICE AND POINT CLOUD FIXING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: ZHI-YA LI, Shenzhen (CN); HENG ZHANG, Shenzhen (CN); XIN-YUAN WU, Shenzhen (CN); LU YANG, Shenzhen (CN)

(21) Appl. No.: 14/796,359

(22) Filed: Jul. 10, 2015

(30) Foreign Application Priority Data
Sep. 11, 2014 (CN) 201410460697.0

(51) Int. Cl. G06T 17/20

(52) U.S. Cl. CPC G06T 17/20

(57) ABSTRACT

An electronic device including a processing unit and a storage device receives a point cloud, and converts the point cloud into a mesh model including a first surface and a second surface engaged with the first surface. Then, the processing unit determines a plurality of first boundary points on the first surface, generates a plurality of first projection points for the plurality of first boundary points on the second surface, and generates a first fixed area based on the plurality of first projection points. The processing unit divides the first fixed area into a plurality of first sub-areas and adds a first additional point into each of the plurality of first sub-areas.

### CROSS-REFERENCE TO RELATED APPLICATIONS

This application claims priority to Chinese Patent Application No. 201410460697.0 filed on Sep. 11, 2014 in the China Intellectual Property Office, the contents of which are incorporated by reference herein.

### FIELD

The subject matter herein generally relates to point cloud processing.

### BACKGROUND

When a measuring device scans an object with defects for a point cloud, there is no data for points within the defects. In addition, when the point cloud loses some data, there are defects in the data point.

### BRIEF DESCRIPTION OF THE DRAWINGS

Implementations of the present technology will now be described, by way of example only, with reference to the attached figures, wherein:

FIG. 1 is a block diagram of one embodiment of an electronic device including a point cloud fix system.

FIG. 2 is a block diagram of one embodiment of function modules of the point cloud fix system in the electronic device of FIG. 1.

FIG. 3 illustrates a flowchart of one embodiment of a point cloud fixing method for the electronic device of FIG. 1.

FIG. 4 is a diagrammatic view of one embodiment of a specific point selected with a specific edge for a triangle mesh by the processing unit of the electronic device of

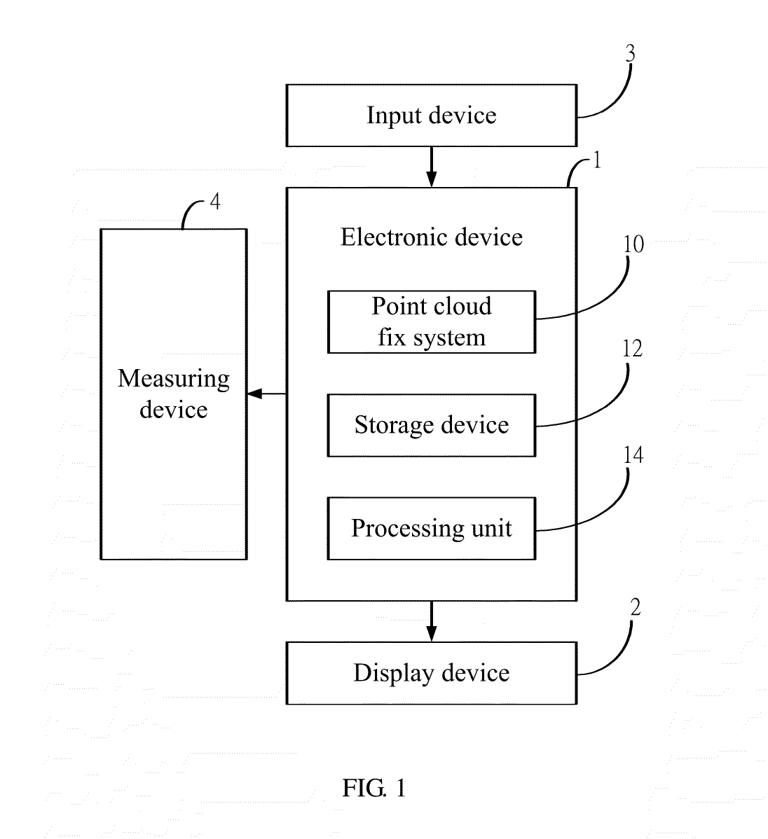

FIG. 1.

FIG. 5 is a diagrammatic view of one embodiment of a mutual vertex of six triangle meshes.

FIG. 6 is a diagrammatic view of one embodiment of a mutual vertex of three triangle meshes.

FIG. 7 is a diagrammatic view of one embodiment of defects in the point cloud.

FIG. 8 is a diagrammatic view of one embodiment of a first fixed area generated by the processing unit of the electronic device of FIG. 1.

FIG. 9 is a diagrammatic view of one embodiment of first sub-areas generated by the processing unit of the electronic device of FIG. 1.

FIG. 10 is a diagrammatic view of one embodiment of first additional points generated by the processing unit of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

A “module,” as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable medium include CDs, DVDs, BLU-RAY, flash memory, and hard disk drives.

FIG. 1 illustrates an embodiment of an electronic device 1 including a point cloud fix system 10. In the embodiment, the electronic device 1 can include a storage device 12 and a processing unit 14, and the electronic device 1 can be coupled to a display device 2, an input device 3 and a measuring device 4. The storage device 12 can store a plurality of instructions. When the plurality of instructions are executed by the processing unit 13, the processing unit 13 receives a point cloud, converts the point cloud into a mesh model having a first surface and a second surface engaged with the first surface, determines a plurality of first boundary points on the first surface, generates a plurality of first projection points for the plurality of first boundary points on the second surface, generates a first fixed area based on the plurality of first projection points, divides the first fixed area into a plurality of first sub-areas, and adds a first additional point into each of the plurality of first sub-areas.

In at least one embodiment, the processing unit 14 receives a point cloud and converts the point cloud into a mesh model having a plurality of mesh surfaces including the first surface and the second surface. In at least one embodiment, the first surface is engaged with and perpendicular to the second surface. In at least one embodiment, the mesh model can include a plurality of triangle meshes formed by the plurality of points. In at least one embodiment, the processing unit 14 can arbitrarily select two neighboring points from the plurality of points in the point cloud and connect the two neighboring points together as a specific edge of a triangle mesh. The processing unit 14 can select a specific point for the specific edge based on a rule that no point in the point cloud is inside a circumscribed circle of the triangle mesh.

In at least one embodiment, when the processing unit 14 determines whether one of the points in the point cloud is a mesh boundary point, the processing unit 14 selects a plurality of specific triangle meshes from the triangle meshes in the mesh model. The point to be determined is a vertex in each of the plurality of specific triangle meshes.

Then, the processing unit 14 measures each of the plurality of included angles around the vertex and computes the sum of the plurality of included angles around the vertex. When the sum of the plurality of included angles is less than 360 degrees, the point is determined to be a mesh boundary point.

In at least one embodiment, the processing unit 14 can compute a first virtual plane and a first normal vector based on a specific algorithm. In at least one embodiment, the specific algorithm can include the least squares method and the quasi-Newton algorithm. Thus, the processing unit 14 can estimate a first initial plane through the plurality of points on the first surface based on the least squares method, and generate the first normal vector and the first virtual plane through the first initial plane based on the quasi-Newton algorithm. The processing unit 14 can select the first boundary points from the mesh boundary points based on the first virtual plane. In at least one embodiment, the first virtual plane can be a formula of the first surface. In at least one embodiment, the processing unit 14 can compute a second virtual plane and a second normal vector based on the specific algorithm. The processing unit 14 can select the second boundary points from the mesh boundary points based on the second virtual plane. In at least one embodiment, the second virtual plane can be a formula of the second surface.

The processing unit 14 generates first projection points for the first boundary points on the second surface, and generates a first fixed area based on the first projection points. Since the first surface is perpendicular to the second surface, the first projection points formed by projecting the first boundary points on the second surface are still on the first surface. The first fixed area is a first closed area surrounded by the plurality of first boundary points and the plurality of first projection points. In at least one embodiment, the processing unit 14 generates second projection points for the second boundary points on the first surface, and generates a second fixed area based on the second projection points. The second fixed area is a second closed area surrounded by the plurality of second boundary points and the plurality of second projection points.

The processing unit 14 divides the first fixed area into first sub-areas and the second fixed area into second sub-areas. The processing unit 14 arbitrarily adds a first additional point into each of the first sub-areas, and adds a second additional point into each of the second sub-areas.

In at least one embodiment, the processing unit 14 can fix defects on two mesh surfaces for the point cloud. In at least one embodiment, when the defects to be fixed are located on the engaged area of the two mesh surfaces perpendicular to each other, the processing unit 14 can fix the point cloud by the point cloud fixing method.

The storage device 12 can be a non-volatile computer readable storage medium that can be electrically erased and reprogrammed, such as read-only memory (ROM), random-access memory (RAM), erasable programmable ROM (EPROM), electrically EPROM (EEPROM), hard disk, solid state drive, or other forms of electronic, electromagnetic, or optical recording medium. In at least one embodiment, the storage device 12 can include interfaces that can access the aforementioned computer readable storage medium to enable the electronic device 1 to connect to and access such computer readable storage medium. In another embodiment, the storage device 12 can include network accessing device to enable the electronic device 1 to connect and access data stored in a remote server or a network-attached storage.

The processing unit 14 can be a processor, a central processing unit (CPU), a graphic processing unit (GPU), a system on chip (SoC), a field-programmable gate array (FPGA), or a controller for executing the program instruction in the storage device 12. The storage device 12 can be static RAM (SRAM), dynamic RAM (DRAM), EPROM, EEPROM, flash memory or other types of computer memory. The processing unit 14 can further include an embedded system or an application specific integrated circuit (ASIC) having embedded program instructions.

In at least one embodiment, the electronic device 1 can be a server, a desktop computer, a laptop computer, or other electronic devices. Moreover, FIG. 1 illustrates only one example of an electronic device 1, and other examples can include more or fewer components than illustrated, or have a different configuration of the various components in other embodiments.

The display device 2 can display the measured information. Thus, the display device 2 can include a display device using liquid crystal display (LCD) technology, or light emitting polymer display (LPD) technology, although other display technologies can be used in other embodiments.

The input device 3 can input data, command, and information into the electronic device 1. Thus, the input device 3 can include a keyboard, a mouse, and a wired or wireless input device for providing an input to the electronic device 1.

The measuring device 4 can scan an object located in the measuring device 4 by an electronic coupler in a plurality of directions and measure data of a plurality of points for the object to generate a point cloud. The data can be stored in the storage device 12. The form of the data can be a TXT form, and the data can store three coordinates of each of the points in the point cloud.

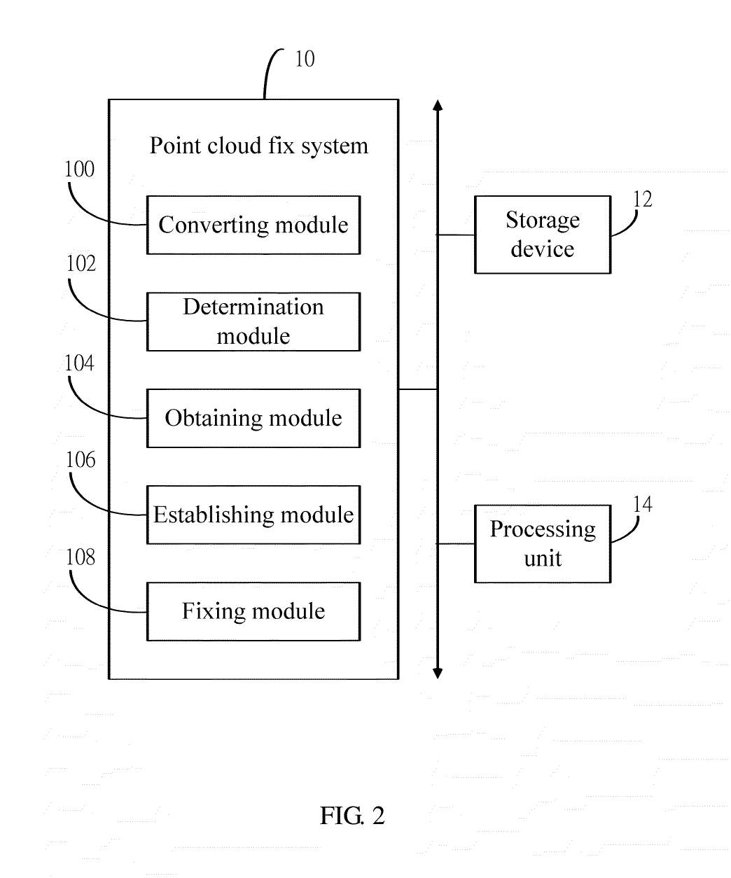

FIG. 2 illustrates an embodiment of function modules of the point cloud fixing system 10 in the electronic device 1 of FIG. 1. In at least one embodiment, the point cloud fixing system 10 can include one or more modules, for example, a converting module 100, a determination module 102, an obtaining module 104, an establishing module 106 and a fixing module 108.

The converting module 100 can receive a point cloud, and convert the point cloud into a mesh model. The mesh model includes a first surface and a second surface engaged with the first surface. The determination module 102 determines a plurality of mesh boundary points of the mesh model. Then, the obtaining module 104 obtains a plurality of first boundary points on the first surface from the plurality mesh boundary points. The establishing module 106 generates a plurality of first projection points for the plurality of first boundary points on the second surface, and generates a first fixed area based on the plurality of first projection points. The fixing module 108 divides the first fixed area into a plurality of first sub-areas and adds a first additional point into each of the plurality of first sub-areas.

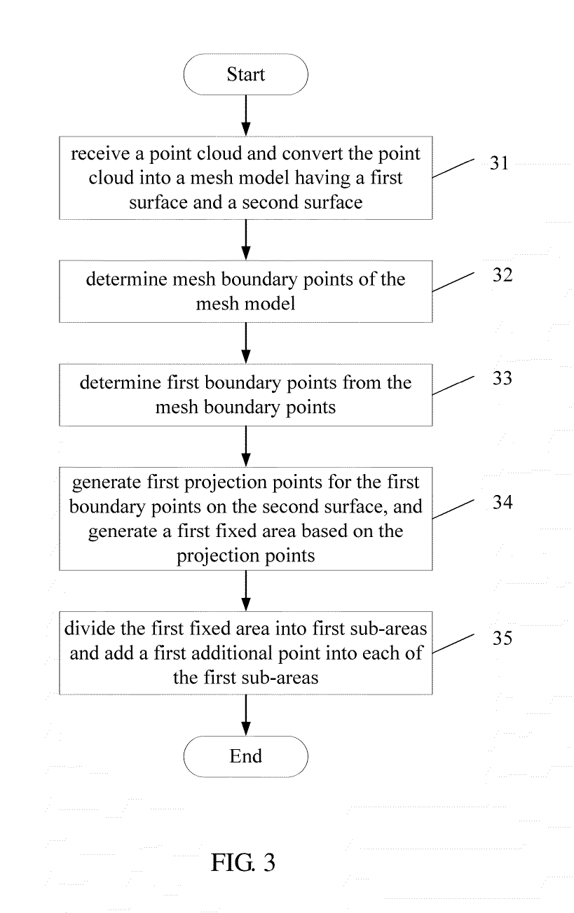

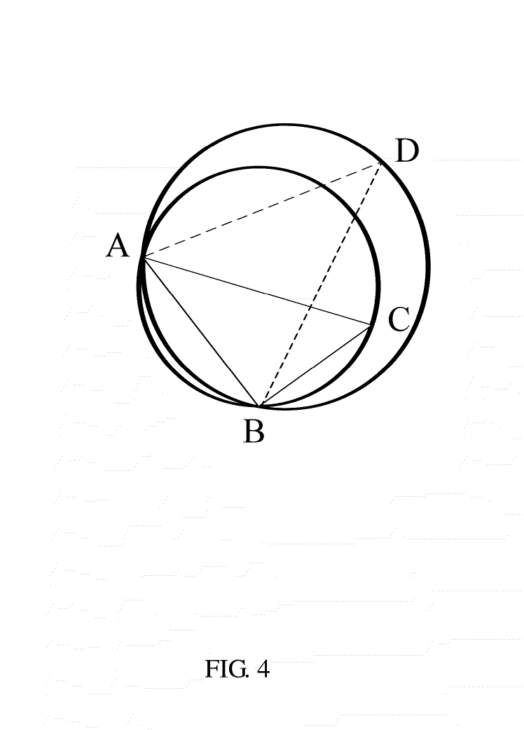

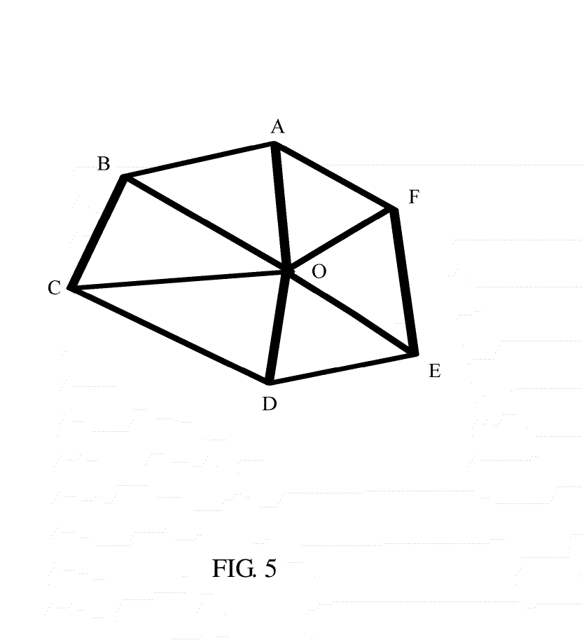

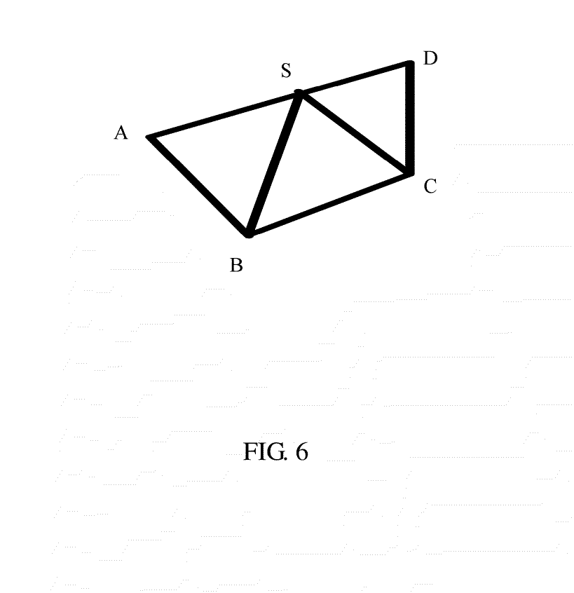

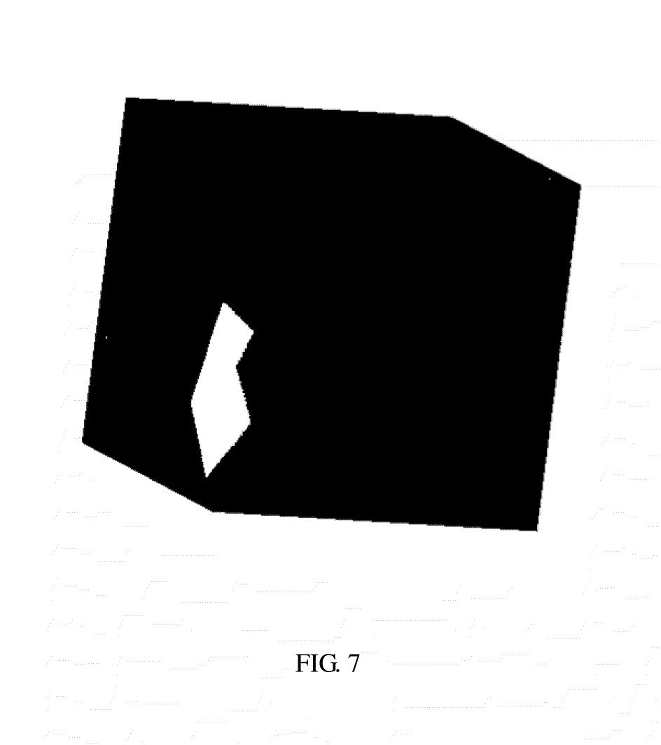

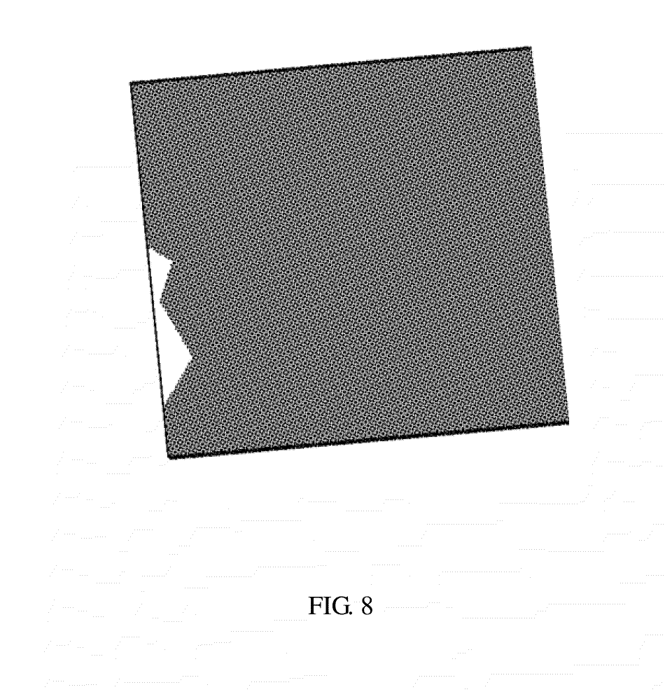

FIG. 3 illustrates a flowchart in accordance with an example embodiment. The example method is provided by way of example, as there are a variety of ways to carry out the method. The method described below can be carried out using the configuration illustrated in FIGS. 1 and 2, for example, and various elements of these figures are referenced in explaining example method. Each block shown in FIG. 3 represents one or more processes, methods, or subroutines, carried out in the example method. Furthermore, the order of blocks is illustrative only and can change. Additional blocks can be added or fewer blocks can be utilized, without departing from this disclosure. The example method can begin at block 31.

At block 31, the converting module 100 receives a point cloud and converts the point cloud into a mesh model having a first surface and a second surface. In at least one embodiment, the mesh model can have a plurality of mesh surfaces including the first surface and the second surface. In at least one embodiment, the first surface is perpendicular to the second surface.

In at least one embodiment, the converting module 100 can receive the point cloud from the input device 3, the measuring device 4, or the storage device 12. In at least one embodiment, the point cloud can include data of a plurality of points. The mesh model can include a plurality of triangle meshes formed by the plurality of points.

In at least one embodiment, the converting module 100 can arbitrarily select two neighboring points from the plurality of points in the point cloud and connect the two neighboring points together as a specific edge of a triangle mesh. The converting module 100 can select a specific point for the specific edge based on a rule that no point in the point cloud is inside a circumscribed circle of the triangle mesh. When the circumscribed circle of the triangle mesh includes another point of the point cloud, the selection by the converting module 100 is wrong. Thus, the converting module 100 can make the selection again to generate another triangle mesh. When each of the points in the point cloud is used to establish the triangle meshes, the plurality of mesh surfaces including the first surface and the second surface are formed.

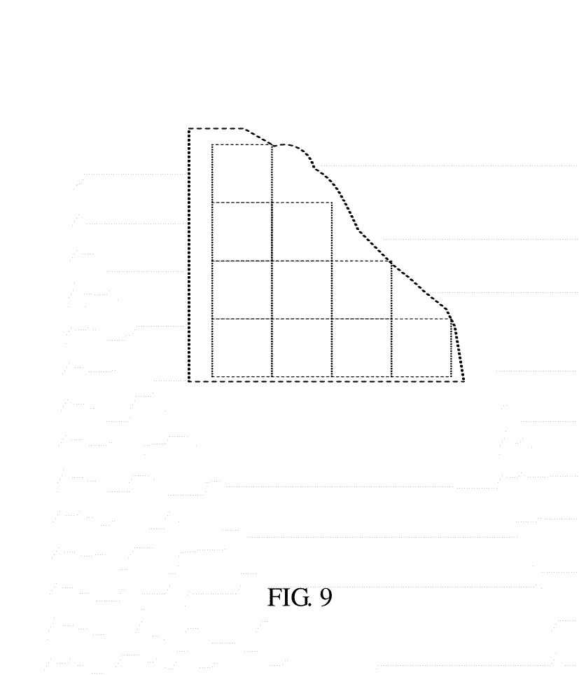

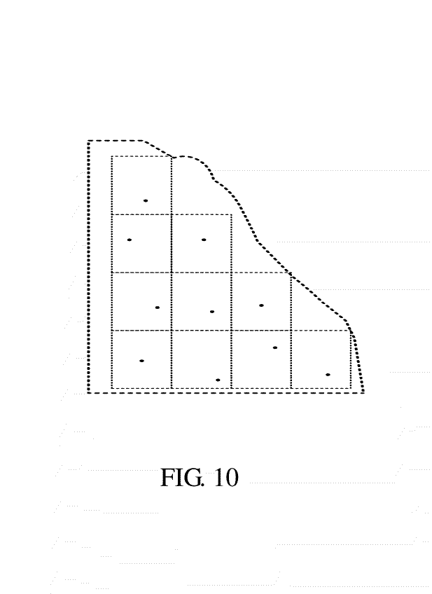

FIG. 4 illustrates that the converting module 100 can select a point in the point cloud for the specific edge as the specific point, such as the point C. The converting module 100 selects two neighboring points A and B from four points A, B, C, and D, and connects the point A with the point B to generate a specific edge AB. When the converting module 100 selects a specific point D for the specific edge AB, there is a point C in the circumscribed circle of the triangle mesh ABD. Thus, the selection of the specific point D is wrong. When the converting module 100 selects a specific point C for the specific edge AB, there is no point in the circumscribed circle of the triangle mesh ABC, thus, the selection of the specific point C meets the selection rule, and the triangle mesh ABC can be one of the triangle meshes in the mesh model. Then, the converting module 100 can select another two points B and C or A and C for another specific edge to generate the other triangle meshes. Thus, the converting module 100 can establish all the triangle meshes to generate the plurality of mesh surfaces.

At block 32, the determination module 102 determines mesh boundary points of the mesh model. In at least one embodiment, the determination module 102 can determine whether each of the plurality of points in the point cloud is a mesh boundary point.

When the determination module 102 determines whether one of the points in the point cloud is a mesh boundary point, the determination module 102 selects a plurality of specific triangle meshes. The point to be determined is a vertex in each of the plurality of specific triangle meshes. Then, the determination module 102 measures each of the plurality of included angles around the vertex, and computes the sum of the plurality of included angles around the vertex. When the sum of the plurality of included angles is equal to 360 degrees, the point is determined not to be a mesh boundary point. When the sum of the plurality of included angles is less than 360 degrees, the point is determined to be a mesh boundary point.

FIG. 5 illustrates that a point O is a mutual vertex of six triangle meshes. The determination module 102 can measure six included angles ∠AOB, ∠BOC, ∠COD, Z DOE, Z EOF, and Z FOA around the point O, and compute the sum of the six included angles. Since the sum of the six included angles is equal to 360 degrees, the determination module 102 can determine that the point O is not a mesh boundary point.

FIG. 6 illustrates that a point S is a mutual vertex of three triangle meshes. The determination module 102 can measure three included angles ∠ASB, ∠BSC, and ∠CSD around the point S, and compute the sum of the three included angles. Since the sum of the three included angles is less than 360 degrees, the determination module 102 can determine that the point S is a mesh boundary point.

At block 33, the obtaining module 104 determines a plurality of first boundary points on the first surface from the mesh boundary points. In at least one embodiment, the obtaining module 104 determines a plurality of second boundary points on the second surface from the mesh boundary points.

In at least one embodiment, the obtaining module 104 can compute a first virtual plane and a first normal vector based on a specific algorithm. In at least one embodiment, the specific algorithm can include the generalized least squares method and the quasi-Newton algorithm. Thus, the obtaining module 104 can estimate a first initial plane through the plurality of points on the first surface based on the generalized least squares method, and generate the first normal vector and the first virtual plane through the first initial plane based on the quasi-Newton algorithm. In at least one embodiment, the quasi-Newton iterative algorithm can be executed based on a formula,

$$f ( x ) = \sqrt[Min]{\sum {( \sqrt{{x 2 - x 1 )}^{2} + {( y 2 - y 1 )}^{2} + {( z 2 - z 1 )}^{2}} )}^{2} / n ,}$$

wherein (x1, y1, z1) is the coordinates of the plurality of points on the first surface, (x2, y2, z2) is the coordinates of a point on the virtual plane, and “n” is the number of the points on the first surface. The obtaining module 104 can select the first boundary points from the mesh boundary points based on the first virtual plane. In at least one embodiment, the first virtual plane can be a formula of the first surface.

In at least one embodiment, the obtaining module 104 can estimate a second initial plane through the plurality of points on the second surface based on the generalized least squares method, and generate a second normal vector and a second virtual plane through the second initial plane based on the quasi-Newton algorithm. The obtaining module 104 can select the second boundary points from the mesh boundary points based on the second virtual plane. In at least one embodiment, the second virtual plane can be a formula of the second surface.

At block 34, the establishing module 106 generates first projection points for the first boundary points on the second surface, and generates a first fixed area based on the first projection points. In at least one embodiment, the establishing module 106 generates second projection points for the second boundary points on the first surface, and generates a second fixed area based on the second projection points.

In at least one embodiment, the first fixed area and the second fixed area determined by the establishing module 106 are formed by defects between the first surface and the second surface in the point cloud. FIG. 7 illustrates that the defects between two surfaces is formed in the point cloud.

In at least one embodiment, when the establishing module 106 measures one of the first projection points for one of the first boundary points P₁ (X₁₁, Y₁₁, Z₁₁), the establishing module 106 will set the first projection point as P₂ (X₁₂, Y₁₂, Z₁₂). If the second virtual plane is A₂X+B₂Y+C₂Z+D₂=0, X₁₂ is equal to X₁₁+A₂T, Y₁₂ is equal to Y₁₁+B₂T, and Z₁₂ is equal to Z₁₁+C₂T. In the embodiment, T is equal to −(A₂X₁₁+B₂Y₁₁+C₂Z₁₁+D₂)/(A₂²+B₂²+C₂²). Thus, the establishing module 106 can measure each of the first projection points for the first boundary points, and generate the first fixed area based on the plurality of first projection points. In at least one embodiment, since the first surface is perpendicular to the second surface, the first projection points formed by projecting the first boundary points on the second surface are still on the first surface. Thus, the first fixed area can be a first closed area surrounded by the plurality of first boundary points and the plurality of first projection points. FIG. 8 illustrates that the first fixed area is generated by the establishing module 106.

In at least one embodiment, when the establishing module 106 measures one of the second projection points for one of the second boundary points M₁₁ (X₁₃, Y₁₃, Z₁₃), the establishing module 106 will set the second projection point as M₁₂ (X₁₄, Y₁₄, Z₁₄). If the first virtual plane is A₁X+B₁Y+C₁Z+D₁=0, X₁₄ is equal to X₁₃+A₁T, Y₁₄ is equal to Y₁₃+B₁T, and Z₁₄ is equal to Z₁₃+C₂T. In the embodiment, T is equal to −(A₁X₁₃+B₁Y₁₃+C₁Z₁₃+D₂)/(A₁²+B₁²+C₁²). Thus, the establishing module 106 can measure each of the second projection points for the second boundary points, and generate the second fixed area based on the plurality of second projection points. In at least one embodiment, since the second surface is perpendicular to the first surface, the second projection points formed by projecting the second boundary points on the first surface are still on the second surface. In at least one embodiment, the second fixed area is a second closed area surrounded by the plurality of second boundary points and the plurality of second projection points.

At block 35, the fixing module 108 divides the first fixed area into first sub-areas and adds a first additional point into each of the first sub-areas. In at least one embodiment, the fixing module 108 divides the second fixed area into second sub-areas and adds a second additional point into each of the second sub-areas.

FIGS. 9 and 10 illustrate that the fixing module 108 divides the first fixed area into a plurality of squares. The squares are the first sub-areas to be fixed. The number of the squares can be set by user or set according to the density of the points in the point cloud. The fixing module 108 can arbitrarily add a first additional point into each of the squares to fix the first surface of the point cloud.

In at least one embodiment, the fixing module 108 divides the second fixed area into a plurality of second sub-areas. The number of the second sub-areas can be set by user or set according to the density of the points in the point cloud. The fixing module 108 can arbitrarily add a second additional point into each of the second sub-areas to fix the second surface of the point cloud.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. An electronic device comprising:
a processing unit; and
a storage device that stores a plurality of instructions, when executed by the processing unit, causes the processing unit to:
receive a point cloud;
convert the point cloud into a mesh model including a first surface engaged with a second surface;
determine a plurality of first boundary points on the first surface;
generate a plurality of first projection points for the plurality of first boundary points on the second surface;
generate a first fixed area based on the plurality of first projection points; and
divide the first fixed area into a plurality of first sub-areas and add a first additional point into each of the plurality of first sub-areas.

2. The electronic device according to claim 1, wherein the first fixed area is a first closed area surrounded by the plurality of first boundary points and the plurality of first projection points.

3. The electronic device according to claim 1, wherein the plurality of instructions further cause the processing unit to:
determine a plurality of mesh boundary points of the mesh model.

4. The electronic device according to claim 3, wherein the plurality of instructions further cause the processing unit to:
select a plurality of second boundary points from the plurality mesh boundary points, wherein each of the second boundary points is located on the second surface;
generate a plurality of second projection points for the plurality of second boundary points on the first surface;
generate a second fixed area based on the plurality of second projection points;
divide the second fixed area into a plurality of second sub-areas; and
add a second additional point into each of the plurality of second sub-areas.

5. The electronic device according to claim 4, wherein the second fixed area is a second closed area surrounded by the plurality of second boundary points and the plurality of second projection points.

6. The electronic device according to claim 3, wherein the plurality of instructions further cause the processing unit to:
receive the mesh model having a plurality of mesh surfaces including the first surface and the second surface;
select a point from the point cloud and a plurality of specific triangle meshes from the mesh model, wherein the selected point is a vertex in each of the plurality of specific triangle meshes; and
determine the selected point as one of the plurality of mesh boundary points when the sum of a plurality of included angles around the selected point is less than 360 degrees.

7. The electronic device according to claim 1, wherein the plurality of first sub-areas are squares.

8. A method for fixing a point cloud comprising:
receiving the point cloud;
converting the point cloud into a mesh model including a first surface engaged with a second surface;
determining a plurality of first boundary points on the first surface;
generating a plurality of first projection points for the plurality of first boundary points on the second surface;
generating a first fixed area based on the plurality of first projection points; and
dividing the first fixed area into a plurality of first sub-areas and adding a first additional point into each of the plurality of first sub-areas.

9. The method according to claim 8, wherein the first fixed area is a first closed area surrounded by the plurality of first boundary points and the plurality of first projection points.

10. The method according to claim 8, comprising:
determining a plurality of mesh boundary points of the mesh model.

11. The method according to claim 10, comprising:
selecting a plurality of second boundary points from the plurality mesh boundary points, wherein each of the second boundary points is a point on the second surface;
generating a plurality of second projection points for the plurality of second boundary points on the first surface;
generating a second fixed area based on the plurality of second projection points;
dividing the second fixed area into a plurality of second sub-areas; and
adding a second additional point into each of the plurality of second sub-areas.

12. The method according to claim 11, wherein the second fixed area is a second closed area surrounded by the plurality of second boundary points and the plurality of second projection points.

13. The method according to claim 10, comprising:
receiving the mesh model having a plurality of mesh surfaces including the first surface and the second surface;
selecting a point from the point cloud and a plurality of specific triangle meshes from the mesh model, wherein the selected point is a vertex in each of the plurality of specific triangle meshes; and
determining the selected point as one of the plurality of mesh boundary points when the sum of a plurality of included angles around the selected point is less than 360 degrees.

14. The method according to claim 8, wherein the plurality of first sub-areas are squares.
